(19) United States
(12) Patent Application Publication
(10) Pub. No.: US 2010/0021128 A1
(43) Pub. Date: Jan. 28, 2010

(54) FAST FORWARD MECHANISM FOR DIGITAL VIDEO

(76) Inventors: Chanaveeragouda Virupaxagouda Goudar, Bangalore (IN); Badrinarayanan Santhanakrishnan, Bangalore (IN)

Correspondence Address: TEXAS INSTRUMENTS INCORPORATED, P O BOX 655474, M/S 3999, DALLAS, TX, 75265, US

(21) Appl. No.: 12/177,160

(22) Filed: Jul. 22, 2008

(51) Int. Cl. H04N 5/91

(52) U.S. Cl. 386/68

(57) ABSTRACT

Methods and systems for fast forward mechanism for digital video processed by a digital video player are disclosed. In one embodiment, a method for fast forwarding digital video includes receiving an encoded digital video stream having at least one I frame, at least one P frame, and at least one B frame, determining a set of frames for displaying on a display unit of the digital video player based on a data size of each frame present in the encoded digital video stream, decoding each one of the at least one I frame and the at least one P frame, decoding each one of the at least one B frame only if the each one of the at least one B frame belongs to the set of frames, and forwarding the decoded frames of the set of frames for the displaying on the display unit.

### FIELD OF TECHNOLOGY

Embodiments of the present invention relate to the field of electronics. More particularly, embodiments of the present invention relate to digital video application.

### BACKGROUND

In a typical digital video encoding system, a digital video stream is compressed as intra-coded (I) frames, prediction (P) frames, and/or bi-directional (B) frames. Each I frame may be encoded without using any reference from other frames. Each P frame may be encoded using its own data and/or one of the preceding I or P frame in the digital video stream. Each B frame may be encoded using its own data, data from the preceding I or P frame, and/or data from the subsequent I or P frame. Since no frame is dependent on the B frames, they may be deleted without affecting decoding of the I or P frames.

A popular fast forward mechanism involves decoding and/or displaying a set of frames present in the digital video stream by deleting the B frames. For example, for a group of pictures present in the digital video stream having an encoded frame sequence “IBBPBBPBBPBBPBB” which is according to a moving pictures experts group (MPEG) standard, the fast forward mechanism may be able to increase the speed of the playback rate of the digital video stream by three times only if the I frame and the P frames are displayed. That is, only an encoded frame sequence “IPPPP”, rather than the entirety of the encoded frame sequence “IBBPBBPBBPBBPBB”, may be decoded and/or displayed. However, the speed achieved by the the fast forward mechanism may not be fast enough for some users.

The fast forward speed may be improved only if the I frames are decoded and/or displayed. Thus, a fast forward mechanism based only on the I frames may increase the fast forward speed of the digital video stream according to the MPEG standard by fifteen times. However, displaying the single I frame may result in a discontinuous image of the digital video stream. Accordingly, a user may not be able to pinpoint where he or she wants to stop the fast forward operation since the user may not be able to figure out fast forwarded content of the digital video stream because of its choppy nature.

### SUMMARY

Methods and systems for fast forward mechanism for digital video are disclosed. In one aspect, a method for fast forwarding digital video processed by a digital video player includes receiving an encoded digital video stream including at least one I frame, at least one P frame, and at least one B frame, and determining a set of frames for displaying on a display unit of the digital video player based on a data size of each frame present in the encoded digital video stream. The method further includes decoding each one of the at least one I frame and the at least one P frame, decoding each one of the at least one B frame only if the each one of the at least one B frame belongs to the set of frames, and forwarding the decoded frames of the set of frames for the displaying on the display unit.

In another aspect, a method for fast forwarding digital video processed by a digital video player includes receiving an encoded digital video stream including at least one I frame, at least one P frame, and at least one B frame, and determining a group of frames for displaying on a display unit coupled to the digital video player from the at least one P frame and the at least one B frame based on a data size of each frame of the at least one P frame and the at least one B frame. The method further includes decoding each one of the at least one I frame and the at least one P frame, decoding each one of the at least one B frame only if the each one of the at least one B frame belongs to the group of frames for the displaying, and forwarding the decoded frames of the at least one I frame and the group of frames for the displaying on the display unit.

In yet another aspect, a digital video player includes a fast forward module including a decoder module, a processor, and a memory. The memory includes a set of instructions, when executed by the processor and the decoder module, executes a method of receiving an encoded digital video stream comprising at least one I frame, at least one P frame, and at least one B frame, and determining a set of frames for displaying on a display unit of the digital video player based on a data size of each frame present in the encoded digital video stream. The method further includes decoding each one of the at least one I frame and the at least one P frame, decoding each one of the at least one B frame only if the each one of the at least one B frame belongs to the set of frames, and forwarding the decoded frames of the set of frames for the displaying on the display unit.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Embodiments of the present invention are illustrated by way of an example and not limited to the figures of the accompanying drawings, in which like references indicate similar elements and in which:

FIG. 1 is a block diagram of a digital video player with an exemplary fast forward module, according to one embodiment.

FIG. 2A through FIG. 2D illustrates an exemplary fast forward method performed by the fast forward module of FIG. 1, according to one embodiment.

FIG. 3 is a process flow illustrating an exemplary method for fast forwarding digital video, according to one embodiment.

FIG. 4 is a process flow illustrating another exemplary method for fast forwarding digital video, according to one embodiment.

Other features of the present embodiments will be apparent from the accompanying drawings and from the detailed description that follows.

### DETAILED DESCRIPTION

Methods and systems for fast forward mechanism for digital video are disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

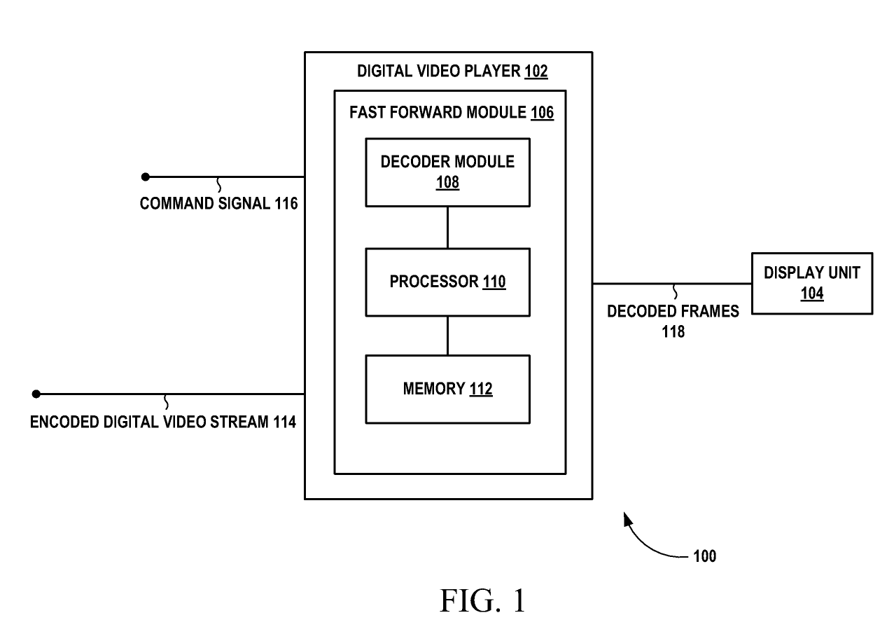

FIG. 1 is a block diagram 100 of a digital video player 102 with an exemplary fast forward module 106, according to one embodiment. Particularly, FIG. 1 illustrates the digital video player 102 coupled to the display unit 104. Further, the digital video player 102 includes a fast forward module 106. In one example embodiment, the fast forward module 106 performs the method of fast forwarding the digital video, processed by the digital video player 102. Further as shown in FIG. 1, the fast forward module 106 includes a decoder module 108, a processor 110, and a memory 112.

In one embodiment, the memory 112 includes a set of instructions, when executed by the processor 110 and the decoder module 108, executes the method of fast forwarding the digital video through the fast forward module 106. In one exemplary implementation, the fast forward module 106 receives an encoded digital video stream 114 having one or more I frames, one or more P frames, and one or more B frames. The fast forward module 106 also determines a set of frames for displaying on the display unit 104 (of the digital video player 102) based on a data size of each frame present in the encoded digital video stream 114. Further, the fast forward module 106 decodes each one of the I frames and the P frames (e.g., through the decoder module 108), and decodes each one of the B frames (e.g., through the decoder module 108) only if the each one of the B frames belongs to the set of frames. In addition, the fast forward module 106 forwards the decoded frames 118 of the set of frames for the displaying on the display unit 104 (e.g., a television screen, a computer screen, and the like).

Further, a number of the set of frames (for the displaying on the display unit 104) is configured based on a command signal 116. In one example embodiment, the encoded digital video stream 114 is based on a video coding experts group (VCEG) standard. In another example embodiment, the encoded digital video stream 114 is based on a moving picture experts group (MPEG) standard. It is appreciated that, the encoded digital video stream 114, according to the MPEG standard, includes a group of pictures in a sequence of I frame, B frame, B frame, P frame, B frame, B frame, P frame, B frame, B frame, P frame, B frame, B frame, P frame, B frame, B frame, P frame.

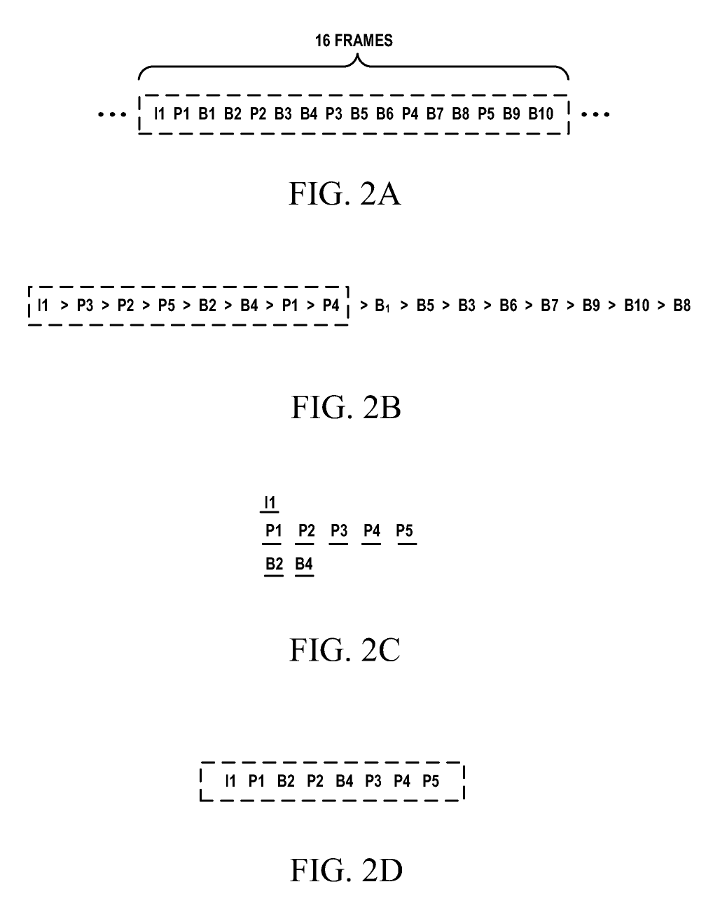

FIG. 2A through FIG. 2D illustrate an exemplary fast forward method performed by the fast forward module 106 of FIG. 1, according to one embodiment. Particularly, FIG. 2A illustrates receiving the encoded digital video stream 114 (e.g., through the fast forward module 106 of FIG. 1) including one or more I frames, one or more P frames, and one or more B frames. In the example embodiment illustrated in FIG. 2A, the encoded digital video stream 114 includes a group of pictures in a sequence of I1 frame, P1 frame, B1 frame, B2 frame, P2 frame, B3 frame, B4 frame, P3 frame, B5 frame, B6 frame, P4 frame, B7frame, B8 frame, P5 frame, B9 frame, B10 frame. For example, the group of pictures includes all the P and B frames present in between one I frame and next consecutive I frame. The fast forward module 106 further identifies the frame type of the each frame present in the encoded digital video stream 114.

FIG. 2B illustrates determining a set of frames, for displaying on the display unit 104 of the digital video player 102, based on a data size of each frame present in the encoded digital video stream 114. In one example embodiment, the fast forward module 106 sorts the I frames, the P frames, and the B frames, based on the data size of the each frame present in the encoded digital video stream 114. Further, the data size of the each frame present in the encoded digital video stream 114 is determined based on a number of bits in each frame. As shown in FIG. 2B, the sequence of the frames after sorting (i.e., based on the data size of the each frame) is as follows.

### I1>P3>P2>P5>B2>B4>P1>P4>B1>B5>B3>B6>B7>B9>B10>B8

In one example embodiment, a number of the set of frames for the displaying is configured based on a command signal 116. Further, the number of bits in the each frame of the P frames and the B frames indicates a degree of content change in the each frame of the P frames and the B frames from a respective reference frame.

Further as shown in FIG. 2B, the fast forward module 106 determines the set of frames for displaying on the display unit 104 of the digital video player 102. In one example embodiment, the set of frames, which is displayed on the display unit 104, includes the I frames and a combination of the P frames and the B frames. In another example embodiment, the set of frames includes the I frames and a subset of the P frames. In yet another example embodiment, the set of frames includes the I frames and a subset of the B frames. In the example embodiment illustrated in FIG. 2B, the frames I1, P3, P2, P5, B2, B4, P1, and P4 depict the set of frames determined to display on the display unit 104 when eight frames in each group of pictures (GOP) are selected to appear on the display unit 104.

In one example embodiment, a B frame is included in the set of frames if size of the B frame is greater than the size of a P frame in the digital encoded video stream 114. In the example embodiment illustrated in FIG. 2B, the size of each of the B2 frame and B4 frame is greater than the size of each of the P1 frame and P4 frame. Therefore, the set of frames includes B2 and B4 frames along with the I1, P3, P2, P5, P1 and P4 frames.

FIG. 2C illustrates decoding the frames of the set of frames for the displaying on the display unit 104. In one embodiment, the decoder module 108 of the fast forward module 106 decodes each I frame and each P frame present in the encoded digital video stream 114, and decodes each one of the B frames only if the each one of the B frames belongs to the set of frames selected for display. As shown in FIG. 2C, the decoder module 108 decodes I1, P1, P2, P3, P4, and P5 present in the encoded digital video stream 114 and decodes only B2 and B4, since B2 and B4 are the only B frames which belong to the set of frames (i.e., I1, P3, P2, P5, B2, B4, P1, and P4).

FIG. 2D illustrates forwarding the decoded frames 118 of the set of frames being displayed on the display unit 104. The decoded frames 118 of the set of frames are reconstructed based on their respective orders in the encoded digital video stream 114. The fast forward module 106 forwards the reconstructed frames to the display unit 104 for the displaying. In the example embodiment illustrated in FIG. 2D, the frames are reconstructed in a sequence of I1, P1, B2, P2, B4, P3, P4 and P5.

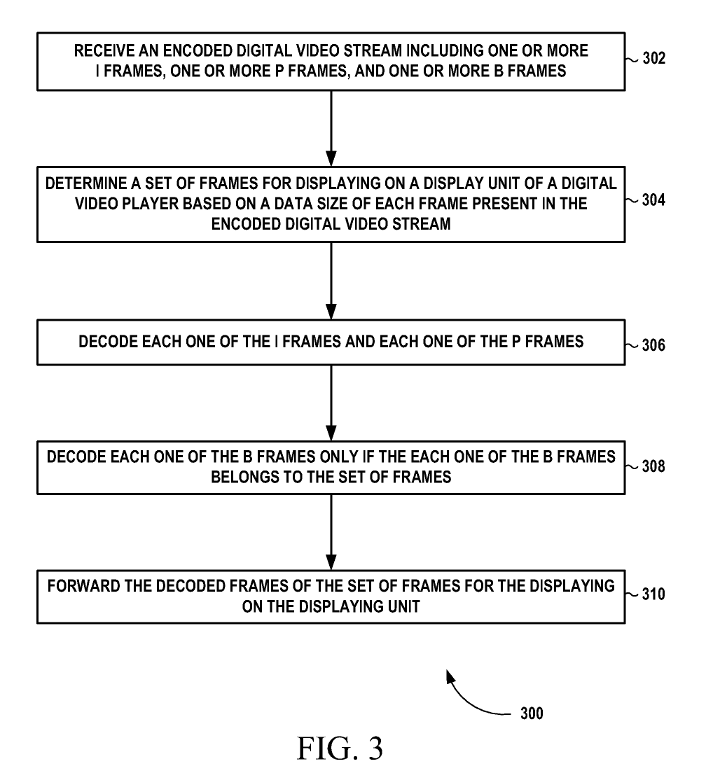

FIG. 3 is a process flow 300 illustrating an exemplary method for fast forwarding digital video, according to one embodiment. Particularly, FIG. 3 illustrates the method for fast forwarding the digital video processed by a digital video player (e.g., the digital video player 102 of FIG. 1). In step 302, an encoded digital video stream (e.g., the encoded digital video stream 114 of FIG. 1), which includdes one or more I frames, one or more P frames, and one or more B frames, is received. In one example embodiment, the receiving the encoded digital video stream further includes identifying a frame type of the each frame present in the encoded digital video stream 114.

In step 304, a set of frames being displayed on a display unit (e.g., the display unit 104 of FIG. 1) of the digital video player 102 is determined based on a data size of the each frame present in the encoded digital video stream 114. In one example embodiment, the set of frames is determined by sorting the I frames, the P frames, and the B frames based on the data size of the each frame present in the encoded digital video stream 114. It is appreciated that, the data size of the each frame (present in the encoded digital video stream 114) is determined based on a number of bits in the each frame. Further, the number of bits in the each frame of the P frames and the B frames indicates a degree of content change in the each frame of the P frames and the B frames from a respective reference frame.

In step 306, each of the I frames and the P frames are decoded. In step 308, each of the B frames are decoded only if the each of the B frames belongs to the set of frames. In step 310, the decoded frames 118 of the set of frames are forwarded for the displaying on the display unit 104.

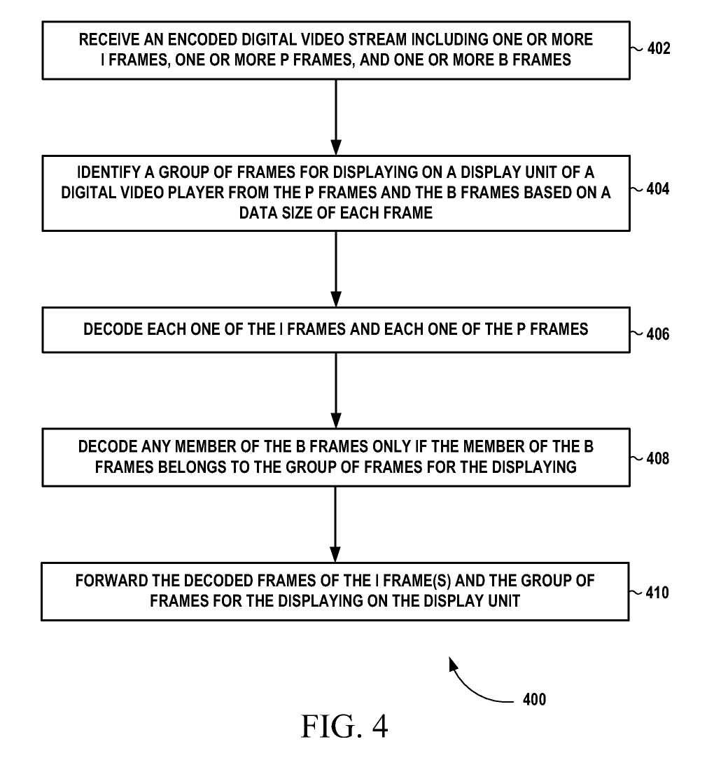

FIG. 4 is a process flow 400 illustrating another exemplary method for fast forwarding digital video, according to one embodiment. Particularly, FIG. 4 illustrates the method for fast forwarding the digital video processed by a digital video player (e.g., the digital video player 102 of FIG. 1). In step 402, an encoded digital video stream (e.g., encoded digital video stream 114 of FIG. 1), which includes one or more I frames, one or more P frames, and one or more B frames, is received. In step 404, a group of frames being displayed on a display unit 104 (e.g., coupled to the digital video player 102) is determined from the P frames and the B frames based on a data size of each frame of the P frames and the B frames. In one embodiment, the group of frames is determined by sorting the I frames, the P frames, and the B frames based on the data size of the each frame. It is appreciated that, the data size of the each frame of the P frames and the B frames is determined based on a number of bits in the each frame. In one example embodiment, the number of bits in the each frame of the P frames and the B frames indicates a degree of content change in the each frame of the P frames and the B frames from a respective reference frame.

In step 406, each one of the I frames and the P frames are decoded (e.g., through the decoder module 108 of FIG. 1). In step 408, each one of the B frames are decoded (e.g., through the decoder module 108 of FIG. 1) only if the each one of the B frames belongs to the group of frames for the displaying on the display unit 104. Further, the decoded frames 118 of the I frames and the group of frames for the displaying are reconstructed based on their respective orders in the encoded digital video stream 114. In step 410, the decoded frames of the I frames and the group of frames are forwarded for the displaying on the display unit 104.

In the above described methods, the set of frames selected for displaying are biased by the size of content data in each frame. For example, between two video frames, if the content is static or of low motion, the content is typically encoded with significantly lower bits and vice-versa. The number of bits consumed to encode a P/B frame typically gives the indication about relative content change between the two frames. The number of bits consumed for each frame is exploited to selectively decode/display frames having relatively more content from frame to frame perspective. Hence, in the above described method, the frames with little motion are dropped compared to dropping frames at a regular interval. This provides the user with more visual content for same number of frames displayed.

The above described fast forward mechanism uses a very simple and easy to implement feature to identify the frames to be dropped while providing more visual content to the user. The above described fast forward mechanism provides more visual content with limited number of frames in fast forward mechanism, providing better visual perception. The above described fast forward mechanism may also enable the user to implement the fast forward mechanism more easily compared a regular frame dropping mechanism.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuitry (ASIC)).

What is claimed is:

1. A method for fast forwarding digital video processed by a digital video player, comprising:
receiving an encoded digital video stream comprising at least one I frame, at least one P frame, and at least one B frame;
determining a set of frames for displaying on a display unit of the digital video player based on a data size of each frame present in the encoded digital video stream;
decoding each one of the at least one I frame and the at least one P frame;
decoding each one of the at least one B frame only if the each one of the at least one B frame belongs to the set of frames; and
forwarding decoded frames of the set of frames for the displaying on the display unit.

2. The method of claim 1, wherein the receiving the encoded digital video stream further comprises identifying a frame type of the each frame present in the encoded digital video stream.

3. The method of claim 1, wherein the determining the set of frames further comprises sorting the at least one I frame, the at least one P frame, and the at least one B frame based on the data size of the each frame present in the encoded digital video stream.

4. The method of claim 3, wherein a number of the set of frames for the displaying is configured based on a command signal.

5. The method of claim 1, wherein the data size of the each frame present in the encoded digital video stream is determined based on a number of bits in the each frame.

6. The method of claim 5, wherein the number of bits in the each frame of the at least one P frame and the at least one B frame indicates a degree of content change in the each frame of the at least one P frame and the at least one B frame from a respective reference frame.

7. The method of claim 1, wherein the encoded digital video stream is based on a video coding experts group (VCEG) standard.

8. The method of claim 1, wherein the encoded digital video stream is based on a moving picture experts group (MPEG) standard.

9. The method of claim 8, wherein the encoded digital video stream according to the MPEG standard comprises a group of pictures in a sequence of I frame, B frame, B frame, P frame, B frame, B frame, P frame, B frame, B frame, P frame, B frame, B frame, P frame, B frame, B frame, P frame.

10. The method of claim 1, wherein the set of frames for the displaying comprises the at least one I frame and a combination of the at least one P frame and the at least one B frame.

11. The method of claim 1, wherein the set of frames for the displaying comprises the at least one I frame and a subset of the at least one P frame.

12. The method of claim 1, wherein the set of frames for the displaying comprises the at least one I frame and a subset of the at least one B frame.

13. The method of claim 1, wherein the decoded frames of the set of frames for the displaying are reconstructed based on their respective orders in the encoded digital video stream.

14. A method for fast forwarding digital video processed by a digital video player, comprising:
receiving an encoded digital video stream comprising at least one I frame, at least one P frame, and at least one B frame;
identifying a group of frames for displaying on a display unit coupled to the digital video player from the at least one P frame and the at least one B frame based on a data size of each frame of the at least one P frame and the at least one B frame;
decoding each one of the at least one I frame and the at least one P frame;
decoding each one of the at least one B frame only if the each one of the at least one B frame belongs to the group of frames for the displaying; and
forwarding decoded frames of the at least one I frame and the group of frames for the displaying on the display unit.

15. The method of claim 14, wherein the data size of the each frame of the at least one P frame and the at least one B frame is determined based on a number of bits in the each frame.

16. The method of claim 15, wherein the number of bits in the each frame of the at least one P frame and the at least one B frame indicates a degree of content change in the each frame of the at least one P frame and the at least one B frame from a respective reference frame.

17. The method of claim 14, wherein the determining the group of frames further comprises sorting the at least one I frame, the at least one P frame, and the at least one B frame based on the data size of the each frame.

18. The method of claim 14, wherein the decoded frames of the at least one I frame and the group of frames for the displaying are reconstructed based on their respective orders in the encoded digital video stream.

19. A digital video player, comprising:
a fast forward module, comprising:
a decoder module;
a processor; and
a memory comprising a set of instructions, when executed by the processor and the decoder module, executes a method comprising:
receiving an encoded digital video stream comprising at least one I frame, at least one P frame, and at least one B frame;
determining a set of frames for displaying on a display unit of the digital video player based on a data size of each frame present in the encoded digital video stream;
decoding each one of the at least one I frame and the at least one P frame;
decoding each one of the at least one B frame only if the each one of the at least one B frame belongs to the set of frames; and
forwarding decoded frames of the set of frames for the displaying on the display unit.

20. The digital video player of claim 19, wherein the display unit comprises a television screen and a computer screen.
